(19) United States
(12) Patent Application Publication
(10) Pub. No.: US 2009/0297841 A1
(43) Pub. Date: Dec. 3, 2009

(54) Composite material with electric contact layer, and method of making the same

(75) Inventors: Takaaki Sasaoka, Tsuchiura (JP); Masahiro Seidou, Tsuchiura (JP); Mineo Washima, Tsuchiura (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Hitachi Cable, Ltd., Tokyo (JP)

(21) Appl. No.: 12/318,952

(22) Filed: Jan. 13, 2009

(30) Foreign Application Priority Data
Jun. 3, 2008 (JP) 2008-145979

(51) Int. Cl. B32B 5/00; B05D 5/12

(52) U.S. Cl. 428/336; 427/78

(57) ABSTRACT

A composite material with an electric contact layer includes a metal substrate, an adhesion layer formed-on a surface of the metal substrate, including an alloy including palladium (Pd) and a Y group metal as a main component selected from titanium (Ti), niobium (Nb), tantalum (Ta) and zirconium (Zr), and having an average thickness of not less than 5 nm and not more than 100 nm, and the electric contact layer formed on a surface of the adhesion layer, including a noble metal selected from gold (Au), platinum (Pt), rhodium (Rh), iridium (Ir) and silver (Ag), and having an average thickness of not less than 1 nm and not more than 20 nm.

The present application is based on Japanese patent application No. 2008-145979 filed Jun. 3, 2008, the entire contents of which are incorporated herein by reference.

### BACKGROND OF THE INVENTION

1. Field of the Invention

This invention relates to a composite material with an electric contact layer which is of a noble metal and formed on the surface of a metal substrate, and a method of making the composite material with the electric contact layer.

2. Description of the Related Art

Conventionally, as typical example of an electric contact layer formed on a metal substrate, gold (Au) plating is well known. As an underlying layer of gold (Au) plating, tin (Sn) plating, nickel (Ni) plating, and silver (Ag) plating are frequently used.

The composite material with electric contact layer having the electric contact layer like this is used for an electrode material of battery cell and an electric contact portion of connector.

In order to make the parts thereof, the composite material with electric contact layer may be variously deformed by press forming.

Further, literature information of related art is shown as follows.

However, gold (Au) plating has a disadvantage that total cost is increased since production cost is largely needed due to the fact that pretreatment etc. are required before coating (or forming the plating on) metals (titanium, aluminum, stainless steel) having a passivation layer formed on the surface, and raw material cost is largely needed due to the fact that gold has to be plated thickly so as to maintain durability.

Therefore, Ni, Sn, Co (cobalt) or Ag plating is to be formed as an underlying layer before forming a noble metal plating.

Japanese patent No. 3956841 discloses that Ag layer and (NiCo) layer are formed as an underlying layer, and Pd layer is formed on the layers as an electric contact layer.

Japanese patent No. 3161805 discloses that Ni layer is used as an underlying layer, and a Pd—Ni alloy is used as an electric contact layer.

Japanese patent application laid-open publication No. 2007-9304 discloses that Sn plating is used as an underlying layer.

In the case that Ni, Sn, Co or Ag is used as an underlying layer as described above, when the underlying layer is used in an environment where the underlying layer itself is corroded electrochemically, a problem of durability occurs. Further, these plating materials have also a disadvantage that a press forming for fabricating parts after the coating treatment is difficult since the plating may be separated (or peeled).

Japanese patent application laid-open publication No. 2007-146250 discloses that metal board of Ti is plated with Au without forming an underlying layer. However, this method has a problem of durability and has a disadvantage that a press forming is difficult.

Japanese patent application laid-open publication No. 2004-158437 discloses that an underlying layer including any one of Ti, Ni, Ta, Nb and Pt is formed and then a noble metal layer is formed thereon for forming an electric contact layer on a substrate for a fuel cell metal separator.

International publication No. WO-2006-126613 discloses that a surface layer is used which is obtained by forming a noble metal layer of Pd on Ti, and heat-treating Ti and Pd for alloying treatment.

However, even if these methods are used, the press forming after coating is still difficult.

### SUMMARY OF THE INVENTION

It is an object of the invention to provide a composite material with an electric contact layer which is capable of decreasing a noble metal usage for an electric contact layer and realizing a press forming without any difficulties after an electric contact layer is formed, and a method of making the same.

(1) According to one embodiment of the invention, a composite material with an electric contact layer comprises:

a metal substrate;

an adhesion layer formed on a surface of the metal substrate, comprising an alloy including palladium (Pd) and a Y group metal as a main component selected from titanium (Ti), niobium (Nb), tantalum (Ta) and zirconium (Zr), and having an average thickness of not less than 5 nm and not more than 100 nm; and

the electric contact layer formed on a surface of the adhesion layer, comprising a noble metal selected from gold (Au), platinum (Pt), rhodium (Rh), iridium (Ir) and silver (Ag), and having an average thickness of not less than 1 nm and not more than 20 nm.

In the above embodiment (1), the following modifications and changes can be made.

(i) The adhesion layer includes palladium (Pd) of not less than 0.02 mass % and not more than 1.8 mass %.

(2) According to another embodiment of the invention, a composite material with an electric contact layer comprises:

a metal substrate;

an adhesion layer formed on a surface of the metal substrate, comprising a Y group metal selected from titanium (Ti), niobium (Nb), tantalum (Ta) and zirconium (Zr), and having an average thickness of not less than 5 nm and not more than 100 nm;

a palladium (Pd) layer formed on a surface of the adhesion layer, comprising palladium (Pd), and having an average thickness of not less than 0.2 nm and not more than 2 nm; and

the electric contact layer formed on a surface of the Pd layer, comprising a noble metal selected from gold (Au), platinum (Pt), rhodium (Rh), iridium (Ir) and silver (Ag), and having an average thickness of not less than 1 nm and not more than 20 nm.

(3) According to another embodiment of the invention, a method of making a composite material with an electric contact layer comprises:

providing a metal substrate;

forming an adhesion layer on a surface of the metal substrate by a gas-phase process in a chamber, the adhesion layer comprising an alloy comprising a Y group metal as a main component selected from titanium (Ti), niobium (Nb), tantalum (Ta) and zirconium (Zr), and not less than 0.02 mass % and not more than 1.8 mass % of palladium (Pd), and having an average thickness of not less than 5 nm and not more than 100 nm; and

forming the electric contact layer on a surface of the adhesion layer by the gas-phase process in the chamber, the electric contact layer comprising a noble metal selected from gold (Au), platinum (Pt), rhodium (Rh), iridium (fr) and silver (Ag), and having an average thickness of not less than 1 nm and not more than 20 nm.

(4) According to another embodiment of the invention, a method of making a composite material with an electric contact layer comprises:

providing a metal substrate;

forming an adhesion layer on a surface of the metal substrate by a gas-phase process in a chamber, the adhesion layer comprising a Y group metal selected from titanium (Ti), niobium (Nb), tantalum (Ta) and zirconium (Zr), and having an average thickness of t1;

forming a palladium (Pd) layer formed on a surface of the adhesion layer by the gas-phase process in the chamber, the Pd layer comprising palladium (Pd) and having an average thickness of t2 so as to satisfy 5 nm≦t1+t2≦100 nm and 0.2 nm≦t2≦2 nm; and

forming the electric contact layer formed on a surface of the Pd layer by the gas-phase process in the chamber, the electric contact layer comprising a noble metal selected from gold (Au), platinum (Pt), rhodium (Rh), iridium (Ir) and silver (Ag), and having an average thickness of not less than 1 nm and not more than 20 nm.

### ADVANTAGES OF THE INVENTION

According to the invention, a composite material with electric contact layer is capable of decreasing a noble metal usage for an electric contact layer and realizing a press forming without any difficulties after an electric contact layer is formed.

### BRIEF DESCRIPTION OF THE DRAWINGS

The preferred embodiments according to the invention will be explained below referring to the drawings, wherein:

FIG. 1 is a cross-sectional view schematically showing a composite material with an electric contact layer in a first embodiment according to the invention;

FIG. 2 is a cross-sectional view schematically showing a composite material with an electric contact layer in a second embodiment according to the invention;

FIG. 3 is an explanatory view schematically showing a method of measuring contact resistance of electric contact layer; and

FIG. 4 is an explanatory view showing a shape of board sample (composite material with electric contact layer) after press forming.

### DETAILED DESCRIPTION OF THE PREFERRED EMBODIMENTS

The preferred embodiments according to the invention will be explained below referring to the drawings.

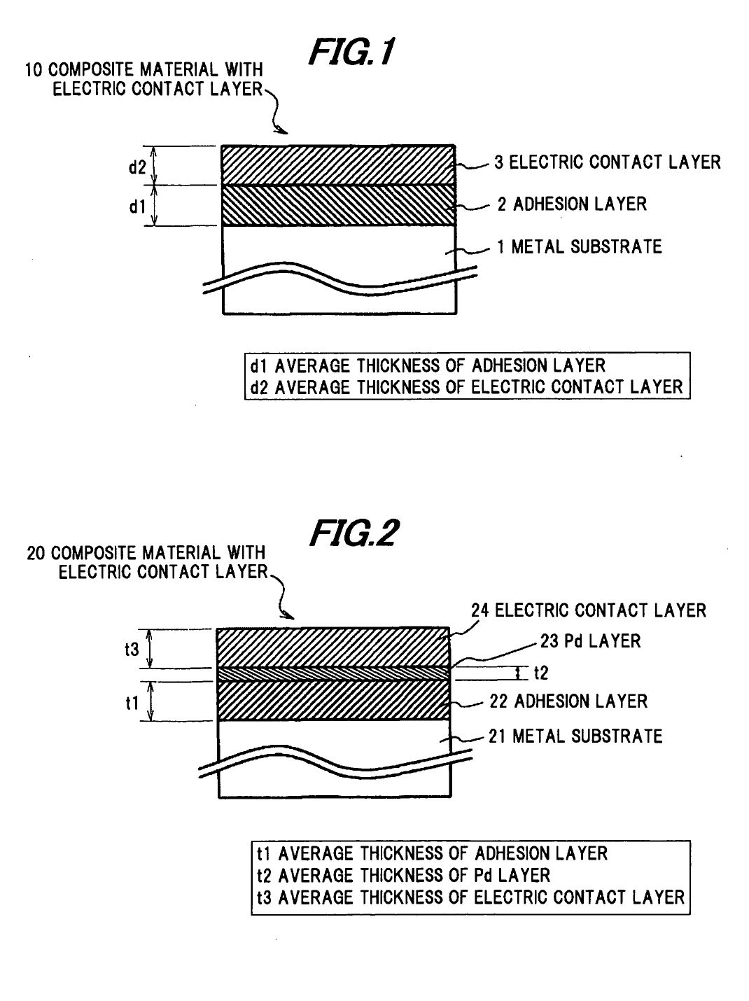

FIG. 1 is a cross-sectional view schematically showing a composite material with electric contact layer in a first embodiment according to the invention.

As shown in FIG. 1, a composite material with electric contact layer 10 in the embodiment comprises a metal substrate 1, an adhesion layer (or underlying layer) 2 formed on the surface of metal substrate 1, comprising an alloy which comprises a Y group metal (selected from titanium (Ti), niobium (Nb), tantalum (Ta) and zirconium (Zr)) as a main component to which not less than 0.02 mass % and not more than 1.8 mass % of palladium (Pd) is added, and having an average thickness d1 of not less than 5 nm and not more than 100 nm, and an electric contact layer 3 formed on the surface of adhesion layer 2, comprising a noble metal (selected from any one of gold (Au), platinum (Pt), rhodium (Rh), iridium (Ir) and silver (Ag)), and having an average thickness d2 of not less than 1 nm and not more than 20 nm.

The metal substrate 1 includes, as preferable main material, (1) metal materials such as Ti, Ti alloy, Nb, Ta, Zr, Ni, Cr or alloy materials of these (alloy materials comprising Ni include invar material (Fe—Co—Cr alloy, Fe—Ni alloy, Fe—Ni—Co alloy), austenitic stainless steel (SUS304, SUS316), kovar material (Fe—Ni—Co alloy), permalloy material (Fe—Ni alloy), hastelloy (Ni—Mo—Fe—Co alloy), inconel (Ni—Fe—Cr—Nb—Mo alloy), and alloy materials not comprising Ni include ferritic stainless steel (SUS430 and the like)), (2) metal materials having composite clad structure of the above-mentioned metal materials, and (3) nichrome board.

The adhesion layer 2 includes, as preferable main material, the same material as the metal substrate 1 selected from the Y group metal (Ti, Nb, Ta and Zr) if the metal substrate 1 comprises a simple substance of metal such as Ti, Nb, Ta or Zr. And, the adhesion layer 2 includes, as preferable main material, any one of the Y group metal, if the metal substrate 1 comprises kovar, permalloy, invar alloy, hastelloy, inconel, alloy comprising Ni, stainless steel, or nichrome board.

The electric contact layer 3 includes, as preferable main material, a noble metal except for Pd (any one of Au, Pt, Rh, Ir and Ag).

The average thickness d1 of the adhesion layer 2 is to be set to the range of not less than 5 nm and not more than 100 nm, since if the average thickness d1 is less than 5 nm, a problem occurs that contact resistance is increased, and if the average thickness d1 is more than 100 nm, a problem occurs that it is easily separated (or peeled) from the metal substrate 1 mechanically.

The addition of Pd to the adhesion layer 2 provides the following three advantages.

(1) If Pd is mixed into the adhesion layer 2 as a component, an adhesion between the adhesion layer 2 and electric contact layer 3 can be improved in comparison with that in the case that Pd is not mixed. This is attributed to the fact that a noble metal does not combine chemically with most of other metals, but if Pd which has a large chemical activity exists in the adhesion layer 2, the chemical combining power between the adhesion layer 2 and electric contact layer 3 can be improved.

(2) Pd allows metals (Ti, Nb, Ta and Zr) having a passivation layer formed on the surface to be improved in corrosion resistance. Thus, the adhesion layer 2 can be improved in durability and subsequently, can prevent the electric contact layer 3 formed on the surface of adhesion layer 2 from peeling (or separation) and leakirig out, so that the electric contact layer 3 can be also improved in durability.

(3) If Pd atoms exist near the surface of adhesion layer 2, the formation of oxide layer is accelerated. The oxide layer acts as a hydrogen barrier to reduce hydrogen absorption caused by generation of hydrogen gas contributing to metal corrosion and then can prevent the adhesion layer 2 from peeling from the metal substrate 1, so that the composite material with electric contact layer can be improved in durability.

The additive amount of Pd to the adhesion layer 2 is to be set to the range of not less than 0.02 mass % and not more than 1.8 mass %, since if the additive amount of Pd is less than 0.02 mass %, a problem occurs that the advantages described above can not be obtained, and if the additive amount of Pd is more than 1.8 mass %, a problem occurs that the adhesion layer 2 easily absorbs hydrogen so as to trigger hydrogen embrittlement or the adhesion layer 2 is peeled from the metal substrate 1.

The average thickness d2 of the electric contact layer 3 is to be set to the range of not less than 1 nm and not more than 20 nm, since if the average thickness d2 is less than 1 nm, a problem occurs that for example, oxidized layer is formed on the adhesion layer 2 and grows to a thickness of not less than 1 nm by long time usage, so that contact resistance is increased that is critical for electric contact, and if the average thickness d2 is more than 20 nm, a problem occurs that strain of the electric contact layer 3 is enlarged, so that it is easily separated from the metal substrate 1 mechanically.

The enlargement of strain of the electric contact layer 3 is caused by volume expansion based on hydrogen gas absorbed therein.

According to the composite material with electric contact layer 10, the adhesion layer 2 to which Pd is added and the electric contact layer 3 are densely combined chemically and then the metal substrate 1 and the electric contact layer 3 are solidly connected through the adhesion layer 2, so that the electric contact layer 3 can be prevented from peeling and can be improved in durability.

The adhesion layer 2 undertakes a role of improving durability so that it is not necessary for the electric contact layer 3 to be thickened in order to maintain durability. Therefore, when the electric contact layer 3 is decreased in thickness, a noble metal usage can be reduced. Further, if the electric contact layer 3 can be decreased in thickness, the internal strain of electric contact layer 3 can be reduced, so that a press forming after layer formation can be carried out.

Further, even in case of metal materials being hard to coating, the electric contact layer 3 satisfying both of reduction of a noble metal usage and durability can be formed, and a press forming after layer formation can be carried out.

Hereinafter, a method of making composite material with electric contact layer 10 will be described.

A method of making the composite material with electric contact layer 10, comprises the step of forming an adhesion layer 2 on the surface of metal substrate 1 disposed in a chamber by a gas-phase process, the adhesion layer 2 comprising an alloy which comprises Y group metal (selected one from titanium (Ti), niobium (Nb), tantalum (Ta) and zirconium (Zr)) as a main component to which not less than 0.02 mass % and not more than 1.8 mass % of palladium (Pd) is added, and having an average thickness d1 of not less than 5 nm and not more than 100 nm, and the step of forming an electric contact layer 3 on the surface of adhesion layer 2 by a gas-phase process in the same chamber, the electric contact layer comprising a noble metal (any one of gold (Au), platinum (Pt), rhodium (Rh), iridium (Ir) and silver (Ag)), and having an average thickness d2 of not less than 1 nm and not more than 20 nm.

The average thickness d1 of the adhesion layer 2, the additive amount of palladium (Pd) to the adhesion layer 2 and the average thickness d2 of the electric contact layer 3 are set to the above-mentioned ranges respectively, which is due to the same reason as explained for the structure of composite material with electric contact layer 10 shown in FIG. 1.

As a method of forming layers, it is preferable to use processing technologies such as deposition, ion beam, sputtering or CVD, but the invention does not limit the processing technologies to the above.

Further, a press forming can be carried out in order to make the parts after the layer formation steps of layers 2, 3, and the layers 2, 3 can be formed after the press forming of metal substrate 1.

Furthermore, oxidation treatment, anode oxidation treatment and the like for sealing pin holes can be carried out in order to improve durability after the formation of the electric contact layer 3.

According to a method of making a composite material with electric contact layer 10, the metal substrate 1 and the electric contact layer 3 are solidly connected through the adhesion layer 2 in which Pd is added, and then the electric contact layer 3 can be prevented from peeling, so that the composite material with electric contact layer can be obtained, having a good durability and an advantage that a press forming can be carried out after the layer formation.

A second embodiment according to the invention will be described below.

FIG. 2 is a cross-sectional view schematically showing a composite material with electric contact layer in the second embodiment according to the invention.

As shown in FIG. 2, a composite material with electric contact layer 20 comprises a metal substrate 21, an adhesion layer 22 formed on the surface of metal substrate 21, comprising Y group metal (selected one from titanium (Ti), niobium (Nb), tantalum (Ta) and zirconium (Zr)), and having an average thickness t1, a palladium (Pd) layer 23 formed on the surface of adhesion layer 22, comprising palladium (Pd), and having an average thickness t2 (the thicknesses t1, t2 satisfy the two formulations: 5 nm≦t1+t2≦100 nm, and 0.2 nm≦t2≦2 nm), and an electric contact layer 24 formed on the surface of Pd layer 23, comprising a noble metal (any one of gold (Au), platinum (Pt), rhodium (Rh), iridium (Ir) and silver (Ag)), and having an average thickness t3 of not less than 1 nm and not more than 20 nm.

As the metal substrate 21, it is preferable to use the same metal materials as the metal substrate 1 shown in FIG. 1.

As main materials of the adhesion layer 22, it is preferable to select from the Y group metal, as in the case of the adhesion layer 2 of the composite material with electric contact layer 10 shown in FIG. 1.

As the electric contact layer 24, it is preferable to select a noble metal except for Pd (any one of Au, Pt, Rh, Ir and Ag) as in the case of the electric contact layer 3 of the composite material with electric contact layer 10 shown in FIG. 1.

A sum (t1+t2) of the average thickness t1 of adhesion layer 22 and the average thickness t2 of Pd layer 23 is to be set to the range of not less than 5 nm and not more than 100 nm, since if the sum (t1+t2) is less than 5 nm, a problem occurs that contact resistance is increased, and if the sum (t1+t2) is more than 100 nm, a problem occurs that it is easily separated from the metal substrate 21 mechanically.

The function of Pd layer 23 is to chemically combine the adhesion layer 22 and the electric contact layer 24 densely. Further, the Pd layer 23 is formed so that the same advantages can be obtained, as in the case of adding Pd to the adhesion layer 2 of the composite material with electric contact layer 10 shown in FIG. 1.

The average thickness t2 of Pd layer 23 is to be set to the range of not less than 0.2 nm and not more than 2 nm, since if the average thickness t2 is less than 0.2 nm, a problem occurs that the above-mentioned advantages can not be obtained, and if the average thickness t2 is more than 2 nm, a problem occurs that the adhesion layer 22 is increased in hydrogen absorption.

The reason why the adhesion layer 22 is increased in hydrogen absorption is that if the Pd layer 23 is a polyatomic layer (more than 2 nm in thickness), stress-strain occurs among the Pd atoms, so that this local strain becomes a factor for hydrogen absorption.

On the other hand, if the thickness t2 of Pd layer 23 is comparable in size to about monoatom (approximately not more than 2 nm in thickness), stress-strain among the Pd atoms is extremely decreased (in the case of perfect monoatom, stress-strain among the Pd atoms is zero), so that the hydrogen absorption which occurs if the Pd layer 23 is a polyatomic layer, does not occur.

The average thickness t3 of electric contact layer 24 is to be set to the range of not less than 1 nm and not more than 20 nm, which is due to the same reason as in the case that the average thickness d2 of electric contact layer 3 is to be set to the range of not less than 1 nm and not more than 20 nm.

A method of making composite material with electric contact layer 20 will be described below.

A method of making a composite material with electric contact layer 20, comprises the step of forming an adhesion layer 22 on a surface of metal substrate 21 disposed in a chamber by a gas-phase process, the adhesion layer 22 comprising a Y group metal (selected one from titanium (Ti), niobium (Nb), tantalum (Ta) and zirconium (Zr)), and having an average thickness of t1, the step of forming a palladium (Pd) layer formed on the surface of adhesion layer 22 by a gas-phase process in the same chamber, the Pd layer 23 comprising palladium (Pd) and having an average thickness of t2 (the thicknesses t1, t2 satisfy the two formulations: 5 nm≦t1+t2≦100 nm, and 0.2 nm≦t2≦2 nm), and the step of forming an electric contact layer 24 formed on the surface of Pd layer 23 by a gas-phase process in the same chamber, the electric contact layer 24 comprising a noble metal (any one of gold (Au), platinum (Pt), rhodium (Rh), iridium (Ir) and silver (Ag)), and having an average thickness t3 of not less than 1 nm and not more than 20 nm.

The sum (t1+t2) of the average thickness t1 of adhesion layer 22 and the average thickness t2 of Pd layer 23, the average thickness t2 of Pd layer 23 and the average thickness t3 of the electric contact layer 24 are set to the above-mentioned ranges respectively, which is due to the same reason as explained for the structure of composite material with electric contact layer 20 shown in FIG. 2.

As a method of forming layers, it is preferable to use processing technologies such as deposition, ion beam, sputtering or CVD, but the invention does not limit the processing technologies to the above.

Further, a press forming can be carried out in order to make the parts after the layer formation steps of layers 22, 23, 24 and the layers 22, 23, 24 can be formed after the press forming of metal substrate 21.

Furthermore, oxidation treatment, anode oxidation treatment and the like for sealing pin holes can be carried out in order to improve durability after the formation of the electric contact layer 24.

According to a method of making a composite material with electric contact layer 20 in the second embodiment, the composite material with electric contact layer 20 can be obtained, having advantages that a noble metal usage can be reduced and a press forming can be carried out after the layer formation, as in the case of the method of making the composite material with electric contact layer 10 shown in FIG. 1.

### EXAMPLE

Evaluation Test of Electric Contact

A conductive property is evaluated by measuring variations in surface contact resistance of board samples (composite material with electric contact layer) before and after an environmental test.

Environmental Test

The environmental test was carried out under an experimental condition of soaking (24 hours, room temperature of about 25 degrees C.) a board sample in a solution which is prepared by adding 1200 ppm of sodium chloride to a solution adjusted to pH 2 by sulfuric acid and purified water.

Further, since the end portion of board sample was not subjected to a layer formation treatment so that the metal substrate at the end portion is exposed, an additional condition of soaking the sample in the solution after the sealing treatment of the end portion with a vinyl masking tape, is applied.

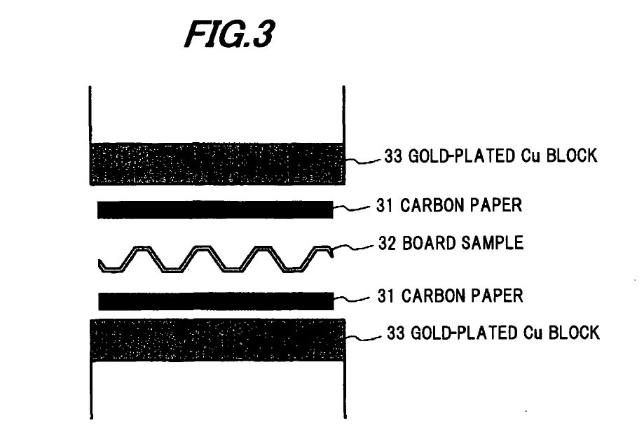

The measurement of surface contact resistance, particularly as shown in FIG. 3, was carried out by measuring contact resistance between a carbon paper 31 (manufactured by Toray Industries, Inc., part number: TGP-H-060) and the board sample 32.

The prepared board sample 32 (area: 2×2 cm²) was sandwiched between gold-plated copper (Cu) blocks 33 through the carbon papers 31 (area: 2×2 cm²), being subjected to weight bearing (10 kg/cm²) by a hydraulic press machine, and the resistance R (mΩ) between the board sample 32 and the carbon papers 31 was measured by a four terminals measuring method (Digital MILLI OHM Meter manufactured by Adex Corporation Ltd., model number: AX-125A). The obtained resistance values were standardized in accordance with the terms of per surface area so that the standardized values were determined as the contact resistance (mΩ·cm²).

Preparation of Samples

Metal substrates were prepared, which have a thickness of 0.1 mm and comprise the following materials respectively, those are, Ti, Nb, Ta, Zr, kovar (Fe—Ni alloy manufactured by The Nilaco Corporation, part number: 633321), 78 permalloy (Ni—Fe alloy manufactured by The Nilaco Corporation, part number:783322), invar (Fe—Ni—Co alloy manufactured by The Nilaco Corporation, part number: 623323), hastelloy C-276 (Ni—Mo alloy manufactured by The Nilaco Corporation, part number:583321), inconel 600 (Ni—Fe—Cr alloy manufactured by The Nilaco Corporation, part number: 603293), stainless steel 430, and stainless steel 316.

A nichrome board (Ni—Cr alloy manufactured by The Nilaco Corporation, part number: 693333) was prepared, which has a thickness of 0.12 mm (for convenience of the material preparation, the thickness is different from the others).

The metal substrates were subjected to layer formation of sputtering process so that the adhesion layer and the electric contact layer were formed thereon in this order. The sputtering process was carried out by using RF sputtering equipment (manufactured by ULVAC, Inc., model number: SH-350).

The layer formation was carried out under argon (Ar) atmosphere, at a pressure of 7 Pa, and RF output was appropriately adjusted according to metal species. Thickness control was carried out every metal species by adjusting the time of layer formation, after preliminarily making a survey of the average speed of layer formation.

Further, in the experimental embodiment, the layer formation was carried out on both surfaces (front and back surfaces) of metal substrate identically.

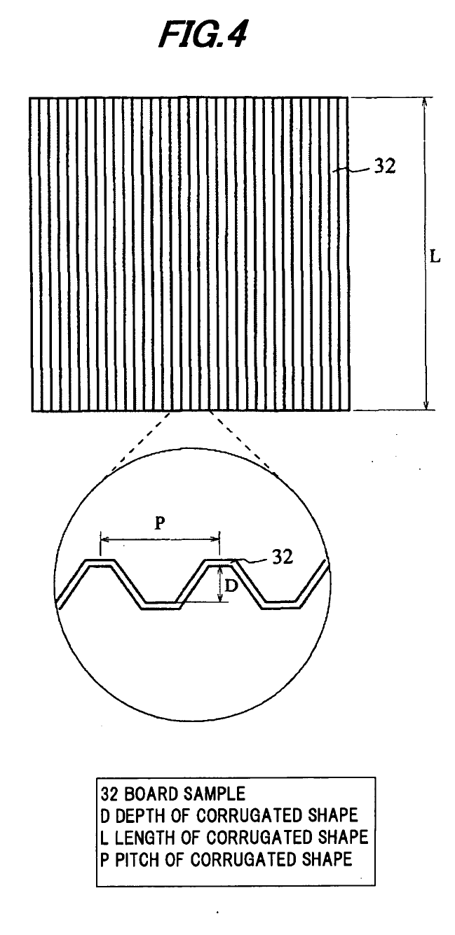

After the layer formation was carried out, a press forming work was carried out as a press forming test by using a mold so as to form a corrugated shape (concavo-convex shape) as shown in FIG. 4. Here, a length L of corrugated shape (grooves and concavities formed so as to extend vertically in FIG. 4) was set to 52 mm, a pitch P of corrugated shape was set to 2.9 mm (×17 pitches) (concavities and convexities formed alternately so as to extend vertically in FIG. 4), and a depth D (difference in height between concavity and convexity formed so as to extend in the direction of depth in FIG. 4) of corrugated shape was set to 0.6 mm.

Further, in practical applications, the shape of groove is not limited to the above-mentioned one, and both surfaces are not needed to be formed as the surface of layer formation (either both surfaces or single surface can be appropriately selected according to the application method).

Explanation of Evaluation Results

Explanation of Tables 1 to 3: The underlying layer (i.e., adhesion layer 2) is formed of a Y group metal-Pd alloy such that the composite material with electric contact layer=metal substrate+adhesion layer+electric contact layer.

TABLE 1

| | | | | | | Electric contact | | |
|---|---|---|---|---|---|---|---|---|
| | | | | | | property | | |
| | | | | | | (Contact | | |
| | | | | | | resistance) | | |
| | | Adhesion layer | | Electric contact | | mΩ · Cm² | | |
| | | Material-Pd | | layer | | | After | |
| | Metal | conc. | Thickness | | Thickness | | environment | Surface state after |
| Sample No. | substrate | (mass %) | (nm) | Material | (nm) | Initial | test | environment test |
| Comp Ex 1 | Ti | — | — | Au | 10.0 | 9.0 | 32.0 | no change |
| Comp Ex 2 | Ti | Ti—0.1Pd | 5.0 | Au | 0.5 | 12 | 24 | no change |
| Example 3 | Ti | Ti—0.1Pd | 5.0 | Au | 1.0 | 8 | 15 | no change |
| Example 4 | Ti | Ti—0.1Pd | 5.0 | Au | 1.0 | 7 | 12 | no change |
| Example 5 | Ti | Ti—0.1Pd | 5.0 | Au | 10.0 | 7 | 10 | no change |
| Example 6 | Ti | Ti—0.1Pd | 5.0 | Au | 20.0 | 7 | 10 | no change |
| Comp Ex 7 | Ti | Ti—0.1Pd | 5.0 | Au | 25.0 | 7 | 24 | no change |
| Example 8 | Ti | Ti—0.1Pd | 10.0 | Au | 10.0 | 7 | 12 | no change |
| Example 9 | Ti | Ti—0.1Pd | 100.0 | Au | 10.0 | 7 | 10 | no change |
| Comp Ex 10 | Ti | Ti—0.1Pd | 150.0 | Au | 10.0 | 7 | 33 | surface |
| | | | | | | | | layer peeled |
| Comp Ex 11 | Ti | Ti—0.1Pd | 10.0 | Pt | 0.5 | 12 | 24 | no change |
| Example 12 | Ti | Ti—0.1Pd | 10.0 | Pt | 1.0 | 8 | 9 | no change |
| Example 13 | Ti | Ti—0.1Pd | 10.0 | Pt | 20.0 | 7 | 9 | no change |
| Comp Ex 14 | Ti | Ti—0.1Pd | 10.0 | Pt | 25.0 | 7 | 22 | no change |
| Example 15 | Ti | Ti—0.1Pd | 10.0 | Ru | 1.0 | 8 | 10 | no change |
| Example 16 | Ti | Ti—0.1Pd | 10.0 | Ru | 20.0 | 7 | 9 | no change |
| Example 17 | Ti | Ti—0.1Pd | 10.0 | Ir | 1.0 | 8 | 10 | no change |
| Example 18 | Ti | Ti—0.1Pd | 10.0 | Ir | 20.0 | 7 | 9 | no change |
| Example 19 | Ti | Ti—0.1Pd | 10.0 | Rh | 1.0 | 8 | 10 | no change |
| Example 20 | Ti | Ti—0.1Pd | 10.0 | Rh | 20.0 | 7 | 9 | no change |
| Example 21 | Ti | Ti—0.1Pd | 10.0 | Ag | 1.0 | 8 | 10 | no change |
| Example 22 | Ti | Ti—0.1Pd | 10.0 | Ag | 20.0 | 7 | 9 | no change |

Notes:
Measurement results are obtained under the conditions that Ti is used for a metal substrate, and thickness of adhesion layer, material of electric contact layer, and thickness of electric contact layer are changed.
Comp Ex: Comparative Example

TABLE 2

| | | | | | | Electric contact | | |
|---|---|---|---|---|---|---|---|---|
| | | | | | | property | | |
| | | | | | | (contact | | |
| | | | | | | resistance) | | |
| | | Adhesion layer | | Electric contact | | mΩ · Cm² | | |
| | | Material-Pd | | layer | | | After | |
| | Metal | conc. | Thickness | | Thickness | | environment | Surface state after |
| Sample No. | substrate | (mass %) | (nm) | Material | (nm) | Initial | test | environment test |
| Comp Ex 23 | SUS430 | Ti—0.01Pd | 10.0 | Au | 1.0 | 9 | 23 | no change |
| | | | | | | | | HC = 10 ppm |
| Example 24 | SUS430 | Ti—0.02Pd | 10.0 | Au | 1.0 | 7 | 15 | no change |
| | | | | | | | | HC = 20 ppm |
| Example 25 | SUS430 | Ti—0.5Pd | 10.0 | Au | 1.0 | 7 | 15 | no change |
| | | | | | | | | HC = 40 ppm |
| Example 26 | SUS430 | Ti—1.0Pd | 10.0 | Au | 1.0 | 7 | 15 | no change |
| | | | | | | | | HC = 60 ppm |
| Example 27 | SUS430 | Ti—1.8Pd | 10.0 | Au | 1.0 | 8 | 15 | no change |
| | | | | | | | | HC = 100 ppm |
| Comp Ex 28 | SUS430 | Ti—2.0Pd | 10.0 | Au | 1.0 | 7 | 15 | surface layer |
| | | | | | | | | peeled |
| | | | | | | | | HC = 2000 ppm |
| Example 29 | Nb | Nb—0.1Pd | 100 | Au | 1.0 | 8 | 15 | no change |
| Example 30 | Nb | Nb—0.1Pd | 100 | Pt | 1.0 | 7 | 15 | no change |
| Example 31 | Nb | Nb—0.1Pd | 100 | Ir | 1.0 | 8 | 15 | no change |
| Comp Ex 32 | Nb | Nb—0.1Pd | 100 | Ru | 1.0 | 8 | 15 | no change |
| Example 33 | Nb | Nb—0.1Pd | 100 | Ag | 1.0 | 7 | 15 | no change |
| Example 34 | Ta | Ta—0.1Pd | 100 | Au | 1.0 | 7 | 15 | no change |
| Example 35 | Zr | Zr—0.1Pd | 100 | Au | 1.0 | 7 | 15 | no change |
| Example 36 | kovar | Ti—0.1Pd | 100 | Au | 1.0 | 7 | 15 | no change |
| Example 37 | permalloy | Ti—0.1Pd | 100 | Au | 1.0 | 7 | 15 | no change |
| Example 38 | invar | Ti—0.1Pd | 100 | Au | 1.0 | 7 | 15 | no change |
| Example 39 | hastelloy | Ti—0.1Pd | 100 | Au | 1.0 | 7 | 15 | no change |
| Example 40 | inconel | Ti—0.1Pd | 100 | Au | 1.0 | 7 | 15 | no change |
| Example 41 | Ni—Cr | Ti—0.1Pd | 100 | Au | 1.0 | 7 | 15 | no change |
| Example 42 | SUS430 | Ti—0.1Pd | 100 | Au | 1.0 | 7 | 15 | no change |
| Example 43 | SUS316 | Ti—0.1Pd | 100 | Au | 1.0 | 7 | 15 | no change |
| Comp Ex 44 | SUS316 | — | — | Au | 1.0 | 9 | 32 | no change |

Notes:
Measurement results are obtained under the conditions that a material other than Ti is used for a metal substrate, and Pd concentration is changed.
Comp Ex: Comparative Example
HC: hydrogen content of whole sample

TABLE 3

| | | | | | | Electric contact | | |
|---|---|---|---|---|---|---|---|---|
| | | | | | | property | | |
| | | | | | | (contact | | |
| | | | | Electric contact | | resistance) | | |
| | | Adhesion layer | | layer | | mΩ · Cm² | | |
| | Metal | Material-Pd | Thickness | | Thickness | | After | Surface state after |
| Sample No. | substrate | conc. (mass %) | (nm) | Material | (nm) | Initial | environment test | environment test |
| Example 45 | SUS430 | Nb—0.1Pd | 10.0 | Au | 1.0 | 7 | 15 | no change |
| Example 46 | SUS430 | Ta—0.1Pd | 10.0 | Au | 1.0 | 7 | 15 | no change |
| Example 47 | SUS430 | Zr—0.1Pd | 10.0 | Au | 1.0 | 7 | 15 | no change |
| Example 48 | SUS430 | Nb—0.1Pd | 100.0 | Au | 1.0 | 7 | 15 | no change |
| Example 49 | SUS430 | Ta—0.1Pd | 100.0 | Au | 1.0 | 7 | 15 | no change |
| Example 50 | SUS430 | Zr—0.1Pd | 100.0 | Au | 1.0 | 7 | 15 | no change |
| Example 51 | SUS430 | Nb—0.1Pd | 100.0 | Ag | 1.0 | 7 | 15 | no change |
| Example 52 | SUS430 | Ta—0.1Pd | 100.0 | Ag | 1.0 | 7 | 15 | no change |
| Example 53 | SUS430 | Zr—0.1Pd | 100.0 | Ag | 1.0 | 7 | 15 | no change |
| Example 54 | Invar | Nb—0.1Pd | 10.0 | Au | 1.0 | 7 | 15 | no change |
| Example 55 | Invar | Ta—0.1Pd | 10.0 | Au | 1.0 | 7 | 15 | no change |
| Example 56 | Invar | Zr—0.1Pd | 10.0 | Au | 1.0 | 7 | 15 | no change |
| Example 57 | Invar | Nb—0.1Pd | 100.0 | Au | 1.0 | 7 | 15 | no change |
| Example 58 | Invar | Ta—0.1Pd | 100.0 | Au | 1.0 | 7 | 15 | no change |
| Example 59 | Invar | Zr—0.1Pd | 100.0 | Au | 1.0 | 7 | 15 | no change |
| Example 60 | Invar | Nb—0.1Pd | 100.0 | Ag | 1.0 | 7 | 15 | no change |
| Example 61 | Invar | Ta—0.1Pd | 100.0 | Ag | 1.0 | 7 | 15 | no change |
| Example 62 | Invar | Zr—0.1Pd | 100.0 | Ag | 1.0 | 7 | 15 | no change |

Notes:
Measurement results are obtained under the conditions that Nb, Ta or Zr is used as a main metal for adhesion layer.

Tables 1 to 3 respectively show a layer structure of samples and a measurement result of contact electric resistance of samples before and after an environmental test.

Practical evaluation is given such that samples having a contact electric resistance after environmental test of not less than 20 mΩ·cm² are not applicable for electric contact (Comparative Examples), and samples having a contact electric resistance after environmental test of less than 20 mΩ·cm² are applicable for electric contact (Examples).

Table 1 shows the thicknesses of adhesion layer and electric contact layer, and the examples of a noble metal applicable for electric contact layer.

The case of not having the adhesion layer (Comparative Example 1) and the case of having the adhesion layer of more than 100 nm in thickness (Comparative Example 10) are not applicable, but the cases of having the adhesion layer of the range of not less than 5 nm and not more than 100 nm in thickness (Examples 6, 8 and 9) are applicable.

The cases of having the electric contact layer of beyond the range of not less than 1 nm and not more than 20 nm in thickness (Comparative Examples 2, 7, 11 and 14) are not applicable. A noble metal layer formed from at least one of Au, Pt, Ru, Rh, Ir and Ag is applicable for the electric contact layer.

Examples and Comparative Examples of sample Nos. 23 to 28 of Table 2 show that a Pd additive concentration of the range of not less than 0.02 mass % and not more than 1.8 mass % is applicable for the adhesion layer.

In the case that the Ti concentration is small (Pd 0.01 mass %), a problem is caused (Comparative Example 23), that the contact resistance after an environmental test becomes high. Further, in the case that the Pd concentration is more than 1.8 mass, a problem is caused (Comparative Examples 28), that a peeling of the surface layer of sample occurs after an environmental test.

The hydrogen contents of samples after an environmental test were analyzed. The analysis was carried out by burning the part peeled from sample so as to determine the hydrogen (H) yield generated at the burning. A measurement equipment (manufactured by HORIBA Ltd., model number: EMGA-1110) was used for the analysis.

The higher the Pd concentration, the larger the hydrogen content, and in the case of Comparative Example 28 (Pd concentration: 2 mass %), the peeling of surface layer occurred, it being conceivably due to the embrittlement of surface layer based on the hydrogen absorption into the layer.

Examples of 29 to 35 of Table 2 show that in the case that the metal substrate comprises Nb, Ta, or Zr, the adhesion layer comprising a Ti—Pd alloy, a Nb—Pd alloy, a Ta—Pd alloy, or a Zr—Pd alloy is to be selected respectively.

Examples of 36 to 43 of Table 2 show the particular examples of various metal substrates, in the case that a Ti—Pd alloy is used as the adhesion layer. As shown in Comparative Example 44, the case of not having the adhesion layer is not also applicable.

Table 3 shows the particular examples of various metal substrates, in the case that a Nb—Pd alloy, a Ta—Pd alloy or a Zr—Pd alloy is used as the adhesion layer.

Explanation of Tables 4 to 6: The underlying layer (i.e., adhesion layer 22 and Pd layer 23) is composed of two layers of a Y group metal and Pd, respectively, such that the composite material with electric contact layer=metal substrate+adhesion layer+Pd layer+electric contact layer.

TABLE 4

| | | | | | | Electric contact | | |
|---|---|---|---|---|---|---|---|---|
| | | | | | | property | | |
| | | | | | | (contact | | |
| | | Adhesion layer/ | | | | resistance) | | |
| | | Pd layer | | Electric contact | | mΩ · cm² | | |
| | | Material | | layer | | | After | |
| | Metal | (adhesion layer/ | Thickness | | Thickness | | environment | Surface state after |
| Sample No. | substrate | Pd layer) | (nm) | Material | (nm) | Initial | test | environment test |
| Comp Ex 102 | Ti | Ti/Pd | 10/0.5 | Au | 0.5 | 8 | 24 | no change |
| Example 103 | Ti | Ti/Pd | 10/0.5 | Au | 1.0 | 8 | 15 | no change |
| Example 104 | Ti | Ti/Pd | 10/0.5 | Au | 3.0 | 8 | 12 | no change |
| Example 105 | Ti | Ti/Pd | 10/0.5 | Au | 10.0 | 8 | 10 | no change |
| Example 106 | Ti | Ti/Pd | 10/0.5 | Au | 20.0 | 8 | 10 | no change |
| Comp Ex 107 | Ti | Ti/Pd | 10/0.5 | Au | 25.0 | 8 | 24 | no change |
| Example 108 | Ti | Ti/Pd | 5/0.5 | Au | 10.0 | 8 | 10 | no change |
| Example 109 | Ti | Ti/Pd | 99.5/0.5 | Au | 10.0 | 8 | 10 | no change |
| Comp Ex 110 | Ti | Ti/Pd | 150/0.5 | Au | 10.0 | 8 | 33 | surface layer |
| | | | | | | | | peeled |
| Comp Ex 111 | Ti | Ti/Pd | 10/0.5 | Pt | 0.5 | 12 | 24 | no change |
| Example 112 | Ti | Ti/Pd | 10/0.5 | Pt | 1.0 | 8 | 9 | no change |
| Example 113 | Ti | Ti/Pd | 10/0.5 | Pt | 20.0 | 7 | 9 | no change |
| Comp Ex 114 | Ti | Ti/Pd | 10/0.5 | Pt | 25.0 | 7 | 22 | no change |
| Example 115 | Ti | Ti/Pd | 10/0.5 | Ru | 1.0 | 8 | 10 | no change |
| Example 116 | Ti | Ti/Pd | 10/0.5 | Ru | 20.0 | 7 | 9 | no change |
| Example 117 | Ti | Ti/Pd | 10/0.5 | Ir | 1.0 | 8 | 10 | no change |
| Example 118 | Ti | Ti/Pd | 10/0.5 | Ir | 20.0 | 7 | 9 | no change |
| Example 119 | Ti | Ti/Pd | 10/0.5 | Rh | 1.0 | 8 | 10 | no change |
| Example 120 | Ti | Ti/Pd | 10/0.5 | Rh | 20.0 | 7 | 9 | no change |
| Example 121 | Ti | Ti/Pd | 10/0.5 | Ag | 1.0 | 8 | 10 | no change |
| Example 122 | Ti | Ti/Pd | 10/0.5 | Ag | 20.0 | 7 | 9 | no change |

Notes:
Measurement results are obtained under the conditions that Ti is used for a metal substrate, and thickness of adhesion layer and electric contact layer is changed.
Comp Ex: Comparative Example

TABLE 5

| | | | | | | Electric contact | | |
|---|---|---|---|---|---|---|---|---|
| | | | | | | property | | |
| | | | | | | (contact | | |
| | | Adhesion layer/Pd | | | | resistance) | | |
| | | layer | | Electric contact | | mΩ · cm² | | |
| | | Material | | layer | | | After | |
| | Metal | (adhesion layer/ | Thickness | | Thickness | | environment | Surface state after |
| Sample No. | substrate | Pd layer) | (nm) | Material | (nm) | Initial | test | environment test |
| Comp Ex 123 | SUS430 | Ti/Pd | 10/0.1 | Au | 1.0 | 9 | 15 | no change |
| | | | | | | | | HC = 10 ppm |
| Example 124 | SUS430 | Ti/Pd | 10/0.2 | Au | 1.0 | 7 | 15 | no change |
| | | | | | | | | HC = 20 ppm |
| Example 125 | SUS430 | Ti/Pd | 10/0.5 | Au | 1.0 | 7 | 15 | no change |
| | | | | | | | | HC = 40 ppm |
| Example 126 | SUS430 | Ti/Pd | 10/1 | Au | 1.0 | 7 | 15 | no change |
| | | | | | | | | HC = 60 ppm |
| Example 127 | SUS430 | Ti/Pd | 10/2 | Au | 1.0 | 8 | 15 | no change |
| | | | | | | | | HC = 100 ppm |
| Comp Ex 128 | SUS430 | Ti/Pd | 10/2.5 | Au | 1.0 | 7 | 15 | surface layer |
| | | | | | | | | peeled |
| | | | | | | | | HC = 2000 ppm |
| Example 129 | Nb | Nb/Pd | 99.5/0.5 | Au | 1.0 | 8 | 15 | no change |
| Example 130 | Nb | Nb/Pd | 99.5/0.5 | Pt | 1.0 | 7 | 15 | no change |
| Example 131 | Nb | Nb/Pd | 99.5/0.5 | Ir | 1.0 | 8 | 15 | no change |
| Example 132 | Nb | Nb/Pd | 99.5/0.5 | Ru | 1.0 | 8 | 15 | no change |
| Example 133 | Nb | Nb/Pd | 99.5/0.5 | Ag | 1.0 | 7 | 15 | no change |
| Example 134 | Ta | Ta/Pd | 99.5/0.5 | Au | 1.0 | 7 | 15 | no change |
| Example 135 | Zr | Zr/Pd | 99.5/0.5 | Au | 1.0 | 7 | 15 | no change |
| Example 136 | kovar | Ti/Pd | 99.5/0.5 | Au | 1.0 | 7 | 15 | no change |
| Example 137 | permalloy | Ti/Pd | 99.5/0.5 | Au | 1.0 | 7 | 15 | no change |
| Example 138 | invar | Ti/Pd | 99.5/0.5 | Au | 1.0 | 7 | 15 | no change |
| Example 139 | hastelloy | Ti/Pd | 99.5/0.5 | Au | 1.0 | 7 | 15 | no change |
| Example 140 | inconel | Ti/Pd | 99.5/0.5 | Au | 1.0 | 7 | 15 | no change |
| Example 141 | Ni—Cr | Ti/Pd | 99.5/0.5 | Au | 1.0 | 7 | 15 | no change |
| Example 142 | SUS430 | Ti/Pd | 99.5/0.5 | Au | 1.0 | 7 | 15 | no change |
| Example 143 | SUS316 | Ti/Pd | 99.5/0.5 | Au | 1.0 | 7 | 15 | no change |

Notes:
Measurement results are obtained under the conditions that a material other than Ti is used for metal substrate, and thickness of adhesion layer and Pd layer is changed.
Comp Ex: Comparative Example
HC: hydrogen content of whole sample

TABLE 6

| | | | | | | Electric contact | | |
|---|---|---|---|---|---|---|---|---|
| | | | | | | property | | |
| | | | | | | (contact | | |
| | | Adhesion layer/Pd | | | | resistance) | | |
| | | layer | | Electric contact | | mΩ · cm² | | Surface state |
| | | Material | | layer | | | After | after |
| | Metal | (adhesion layer/ | Thickness | | Thickness | | environment | environment |
| Sample No. | substrate | Pd layer) | (nm) | Material | (nm) | Initial | test | test |
| Comp Ex 144 | SUS430 | Nb/Pd | 10/0.5 | Au | 1.0 | 7 | 15 | no change |
| Example 145 | SUS430 | Ta/Pd | 10/0.5 | Au | 1.0 | 7 | 15 | no change |
| Example 146 | SUS430 | Zr/Pd | 10/0.5 | Au | 1.0 | 7 | 15 | no change |
| Example 147 | SUS430 | Nb/Pd | 99.5/0.5 | Au | 1.0 | 7 | 15 | no change |
| Example 148 | SUS430 | Ta/Pd | 99.5/0.5 | Au | 1.0 | 7 | 15 | no change |
| Example 149 | SUS430 | Zr/Pd | 99.5/0.5 | Au | 1.0 | 7 | 15 | no change |
| Example 150 | SUS430 | Nb/Pd | 99.5/0.5 | Ag | 1.0 | 7 | 15 | no change |
| Example 151 | SUS430 | Ta/Pd | 99.5/0.5 | Ag | 1.0 | 7 | 15 | no change |
| Example 152 | SUS430 | Zr/Pd | 99.5/0.5 | Ag | 1.0 | 7 | 15 | no change |
| Example 153 | invar | Nb/Pd | 99.5/0.5 | Au | 1.0 | 7 | 15 | no change |
| Example 154 | invar | Ta/Pd | 10/0.5 | Au | 1.0 | 7 | 15 | no change |
| Example 155 | invar | Zr/Pd | 10/0.5 | Au | 1.0 | 7 | 15 | no change |
| Example 156 | invar | Nb/Pd | 99.5/0.5 | Au | 1.0 | 7 | 15 | no change |
| Example 157 | invar | Ta/Pd | 99.5/0.5 | Au | 1.0 | 7 | 15 | no change |
| Example 158 | invar | Zr/Pd | 99.5/0.5 | Au | 1.0 | 7 | 15 | no change |
| Example 159 | invar | Nb/Pd | 99.5/0.5 | Ag | 1.0 | 7 | 15 | no change |
| Example 160 | invar | Ta/Pd | 99.5/0.5 | Ag | 1.0 | 7 | 15 | no change |
| Example 161 | invar | Zr/Pd | 99.5/0.5 | Ag | 1.0 | 7 | 15 | no change |

Notes:
Measurement results are obtained under the conditions that Nb, Ta or Zr is used as a main metal for adhesion layer, and thickness of adhesion layer is changed.
Comp Ex: Comparative Example

Tables 4 to 6 respectively show, similarly to Tables 1 to 3, a layer structure of samples and a measurement result of contact electric resistance of samples before and after an environmental test, with regard to Examples and Comparative Examples applied by the case that the underlying layer has a double-layered structure of Y-group metal (Ti, Nb, Ta and Zr) and Pd structure.

In the case that the underlying layer has a Y-group metal and Pd structure, Y-group metal is selected as the adhesion layer and Pd is selected as the Pd layer.

Similarly to Tables 1 to 3, the case that the underlying layer (t1+t2) is the range of not less than 5 nm and not more than 100 nm in thickness is applicable (Examples 105, 108 and 109), but the case that the underlying layer is more than 100 nm in thickness, a problem is caused (Comparative Example 110), that a peeling of the surface layer of sample occurs after an environmental test.

Further, the electric contact layer has a thickness of beyond the range of not less than 1 nm and not more than 20 nm are not applicable (Comparative Examples 102, 107, 111 and 114), since the contact resistance is increased.

Examples and Comparative Examples of sample Nos. 123 to 128 of Table 5 show that the Pd layers having an average thickness of not less than 0.2 nm and not more than 2 nm are applicable. When the Pd layer is thin (Comparative Example 123), a problem is caused that the contact resistance after an environmental test becomes high. Further, in the case that the Pd layer is more than 2 nm in thickness (Comparative Examples 128), a problem is caused that a peeling of the surface layer of sample occurs after an environmental test.

The hydrogen contents of samples after an environmental test were analyzed. The analysis was carried out by burning the part peeled from sample so as to determine the hydrogen (H) yield generated at the burning. A measurement equipment (manufactured by HORIBA Ltd., model number: EMGA-1110) was used for the analysis. The higher the Pd concentration, the larger the hydrogen content, and in the case of Comparative Example 128 (average thickness of Pd layer: 2 nm), the peeling of surface layer occurred, it being conceivably due to the embrittlement of surface layer based on the hydrogen absorption into the layer.

The verification method of these average thicknesses in Examples described above includes an analysis method using such as an ICP (induction coupled plasma) mass analysis, or an XPS (X-ray Photoemission spectroscopy). The method described above can measure the average thickness of the layers respectively, by means that plural random places being desired to be measured of the composite material with electric contact layer are used as analysis samples.

Further, an analysis method using a TEM (transmission electron microscope) can also measure the average thickness as well as the IPC and XPS.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A composite material with an electric contact layer, comprising:
a metal substrate;
an adhesion layer formed on a surface of the metal substrate, comprising an alloy including palladium (Pd) and a Y group metal as a main component selected from titanium (Ti), niobium (Nb), tantalum (Ta) and zirconium (Zr), and having an average thickness of not less than 5 nm and not more than 100 nm; and
the electric contact layer formed on a surface of the adhesion layer, comprising a noble metal selected from gold (Au), platinum (Pt), rhodium (Rh), iridium (Ir) and silver (Ag), and having an average thickness of not less than 1 nm and not more than 20 nm.

2. The composite material with the electric contact layer according to claim 1, wherein the adhesion layer includes palladium (Pd) of not less than 0.02 mass % and not more than 1.8 mass %.

3. A composite material with an electric contact layer, comprising:
a metal substrate;
an adhesion layer formed on a surface of the metal substrate, comprising a Y group metal selected from titanium (Ti), niobium (Nb), tantalum (Ta) and zirconium (Zr), and having an average thickness of not less than 5 nm and not more than 100 nm;
a palladium (Pd) layer formed on a surface of the adhesion layer, comprising palladium (Pd), and having an average thickness of not less than 0.2 nm and not more than 2 nm; and
the electric contact layer formed on a surface of the Pd layer, comprising a noble metal selected from gold (Au), platinum (Pt), rhodium (Rh), iridium (Ir) and silver (Ag), and having an average thickness of not less than 1 nm and not more than 20 nm.

4. A method of making a composite material with an electric contact layer, comprising:
providing a metal substrate;
forming an adhesion layer-on a surface of the metal substrate by a gas-phase process in a chamber, the adhesion layer comprising an alloy comprising a Y group metal as a main component selected from titanium (Ti), niobium (Nb), tantalum (Ta) and zirconium (Zr), and not less than 0.02 mass % and not more than 1.8 mass % of palladium (Pd), and having an average thickness of not less than 5 nm and not more than 100 nm; and
forming the electric contact layer on a surface of the adhesion layer by the gas-phase process in the chamber, the electric contact layer comprising a noble metal selected from gold (Au), platinum (Pt), rhodium (Rh), iridium (Ir) and silver (Ag), and having an average thickness of not less than 1 nm and not more than 20 nm.

5. A method of making a composite material with an electric contact layer, comprising:
providing a metal substrate;
forming an adhesion layer on a surface of the metal substrate by a gas-phase process in a chamber, the adhesion layer comprising a Y group metal selected from titanium (Ti), niobium (Nb), tantalum (Ta) and zirconium (Zr), and having an average thickness of t1;
forming a palladium (Pd) layer formed on a surface of the adhesion layer by the gas-phase process in the chamber, the Pd layer comprising palladium (Pd) and having an average thickness of t2 so as to satisfy 5 nm≦t1+t2≦100 nm and 0.2 nm≦t2≦2 nm; and
forming the electric contact layer formed on a surface of the Pd layer by the gas-phase process in the chamber, the electric contact layer comprising a noble metal selected from gold (Au), platinum (Pt), rhodium (Rh), iridium (Ir) and silver (Ag), and having an average thickness of not less than 1 nm and not more than 20 nm.
